(19) United States
(12) Patent Application Publication
(10) Pub. No.: US 2008/0168997 A1
(43) Pub. Date: Jul. 17, 2008

(54) Cigarette Filter For Reducing Tar And Decreasing Toxicity And Equipment For Producing It

(75) Inventors: Chenxiao Wu, Nanyang (CN); Xuedong Niu, Nanyang (CN); Languang Zhu, Nanyang (CN); Zhixin Shen, Nanyang (CN); Min Li, Nanyang (CN); Li Xiong, Nanyang (CN); Jianping Du, Nanyang (CN)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Chenxiao Wu, Nanyang, Henan (CN)

(21) Appl. No.: 11/908,404

(22) PCT Filed: Jan. 19, 2006
(86) PCT No.: PCT/CN2006/000080

§ 371 Date: Sep. 11, 2007

(30) Foreign Application Priority Data
Mar. 11, 2005 (CN) 200510017410.8

(51) Int. Cl. A24D 3/06; B31C 13/00

(52) U.S. Cl. 131/331; 493/42

(57) ABSTRACT

A cigarette filter for reducing tar and decreasing toxicity and equipment for producing the filter are provided in tobacco field. The rod core is made from staple fiber, specially natural plant fiber, specially wood fiber, more specially short wood pile fiber. The cigarette filter can be the complex filter, or the complex filter with a hollow cylinder, or the triple filter. For modeling the filter made of wood fiber, the invention provides a set of equipments, which includes crushing equipment for wood pulp material, negative pressure equipment for adsorbing and forming twist, and conveying equipment. The equipment can be combined with existing cigarette filter modeling equipment. Because of said solution of the invention, tobacco smoke passes through the filter with large contact area, long course and perdurability. Due to the effective ability of adsorbing and filtrating of wood fibers, amount of tar and other toxicants adsorbed of a single cigarette is decreased availably. The equipment of the invention crushes wood pulp, adsorbs and settles to form binds, then enwraps and presses to form bars, finally creates source materials that can be imported directly into existing cigarette filter modeling equipment.

### FIELD OF THE INVENTION

This invention is categorized into the field of tobacco industry. This new type of filter tip could help reduce the amount of tar residue after burning, decrease the side-effect upon human being and increase the cigarette burning efficiency.

### BACKGROUND

The technology for cigarette of tar-residue reduction and side-effect decrease (TRSD) has been a major research topic and difficult problem for Chinese tobacco industries for many years. Design and selection of different filter tip is being widely used to achieve TRSD. The two main materials used in our country are cellulose acetate (CA) and polypropylene fibrefibre (PF). The avoidless disadvantages exist in those two materials, such as, CA is relying on mass imports with high cost and hard to be decomposed and broken down which would bring the second time pollution. And it couldn't reach the requirement for decreasing the amount of tar-intake per cigarette massively due to its low ability of filtering. PF has the same problems although its low cost, furthermore, it can arise the discomfortable taste for customers and degradable quality of cigarette due to its peculiar smell. Patent NO95120341x is registered by a Japanese company coming up with the new idea in which the filter is produced of patchy filtering material with mesh structure consisted of cellulose ester short fibre inter-twisted together. This is an early thinking of using short fibrefibre as filtering materials with proven higher filtering effect than CA and PF, and better smell and taste than corrugation filter made from woodpulp. One Japanese company has produced the new nonwovens filter made from woodpulp and bond twisted after being planished, in which particular TRSD effect has been proven. The American patent 90104165 also introduced the new method to increase the filtering effect by adding natural fibrefibre (including timber fibre woodpulp) into the nonwoven fibre web. Therefore, the idea of short fibrefibre (natural fibrefibre with timber fiver) replacing CA and PF to increase the filtering effect has been widely accepted. However, the technologies mentioned above have the seemingly can-not-be-solved problem in which the short fibrefibre can not be used to make filter tips by current tip machines due to its poor performance of anti-strain ability particular for timber fibre woodpulp. Therefore, timber fibre woodpulp can either only be added by a mall portion or be produced into corrugation paper which then could be made into tips. Under such circumstances, problems below are needed to be solved, 1, the area between the filter material and smoke is decreased, so does filtering effect. 2, the smoke journey through the tips is short, therefore the filtering efficiency is low. 3, cost is high because the materials can not be produced into tips directly. 4, the timber fibre woodpulp can only be used with bond or other materials in which the intaking resistance is high and the filtering efficiency is low.

Due to the regulations of WTO, especially after china singed the <<Framework Convention on Tobacco Control>>, china needs to decrease the intaking amount of tar and other hazardous things per cigarette. Under huge pressure, Chinese tobacco companies try every effort to find a way for TRSD by either using double-filtering, triple-filtering, extended filter tips and bio-filter tips, or using even advanced expansion process, tobacco-breeding technology, cut tobacco screening process. However, none of them has reached the requirements of the Convention.

### SUMMARY

The new idea by using short fibrefibre (further natural plant fibrefibre, further timber fibre woodpulp, even further short timber fibre woodpulp) for manufacturing the filtering tips directly to solve this long-lasting problem is issued by the inventor who would use those materials mentioned above as the core of the filtering tips, actually called as multiple tips, which are short fibrefibre cores connected with CA and PF, or outside of woodpulp tip core in the general forming paper, hollow tube is configured to form hollow multiple tips, also use CA or PF as front tips materials, woodpulp as intermediate materials and CA or PF as outer tips materials to form ternary tips.

A set of timber-fibre woodpulp moulding machines have also been invented for mass production, which include equipments for timber materials shivering, vacuum absorption and entwisting, tip-figuration passive transportation device in which the products could be used in existing tip-moulding machines. Timber material shivering equipment consists of rotating shaft, which could be one shaft or two extension shafts located on each end of the machine. Crash gear, which would rotate while pressing the materials to bring along the transportation line, and shivering machines including machine shell, shivering cabnit, and shivering round shaft. Machine shell has the input and output, the later is connected with the transportation line. Shivering round shaft can be either vertical round plate with shivering needles or horizontal cylinder with shivering needles. The crash gear is connected to an electromotor by a gear-box. Vacuum absorbing and entwisting equipment is an enclosed molding cabinet with input and output on the shell. This molding cabinet has two partitions, which are vacuum room connected with vacuuming machine with ducts on the input side, and ground-air pressure room on the output side. Partition board is relatively immobile to the machine frame, gas-permeable mesh is designed just between the inner room of hollow molding rotating plate and molding slots which are at the brim of the molding rotating plates. The section of gas-permeable mesh and molding slots are semi-round tracks of slots. There is a molding brush in the molding cabinet, which is riveted to the frame through the rotating shaft. The brush is sunken into another semi-circle track which is just opposite to the semi-circle tracks of slots on the molding rotating plate. Beside the brush, there is a material-returning outlet, which is connected to the material-returning pipe; there is a hollow product-accepting platform with a vacuum absorbing hole at the rear of ground-air pressure room and spout. The platform works with a transportation belt, driver and transmission. The tip-configuration passive transportation device actually consists of front molding gun and rear molding gun which are riveted on the frame. The front molding gun has the motherboard and cover board each with a semi-circle slot. The two slots compose the gun chamber of which the intake has a bugle configuration. There is also a tip-rolling transportation belt works with driver and tension-wheel. The rear molding gun is almost as the same as the front moulding gun except caliber of the outlet is the one of the tips.

The intake amount of tar and other poisonous chemicals per cigarette could be hugely decreased due to the technology introduced above of which larger contact area, longer distance and extended traveling time of smoke through the tip, and peculiarly strong absorbing ability of timber fibre woodpulp. After the experiment under the same circumstances, the new short fibrefibre tip has 17 mg tar per cigarette, with traditional acetum tip 17 mg, and combination tip of short fibrefibre and acetum 11 mg. This has fully approved that the original creation, validity and scientific rightness. By bold imagination and scientific fulfillment, this difficult problem of moulding of short fibre has been eventually solved. Instead of traditional pattern of thread moulding into tips, the whole procedure of timber fibrewoodpulp shivering, being vacuumed and entwisted, and then wrapped and pressed into the existing tip-moulding machines such as 33 or KDF-2 is the pioneer one internationally.

### DESCRIPTION OF THE DRAWINGS

The accompanying drawings, which are incorporated in and constitute a part of specification, illustrate an exemplary embodiment of the present invention and, together with the general description given above and the detailed description of the preferred embodiment given below, serve to explain the principles of the present invention.

FIG. 1, Parts profile of single tip material.

FIG. 2, Parts profile of muti-materials for tips.

FIG. 3, Parts profile of triple-materials for tips.

FIG. 4, Parts profile of hollow tips.

FIG. 5, Parts profile of production assembly lines.

FIG. 6, Parts profile of timber fibrewoodpulp shivering machine.

FIG. 7, parts profile of vacuum absorbing and entwisting machine.

FIG. 8, parts profile of passive transportation equipment.

### DETAILED DESCRIPTION

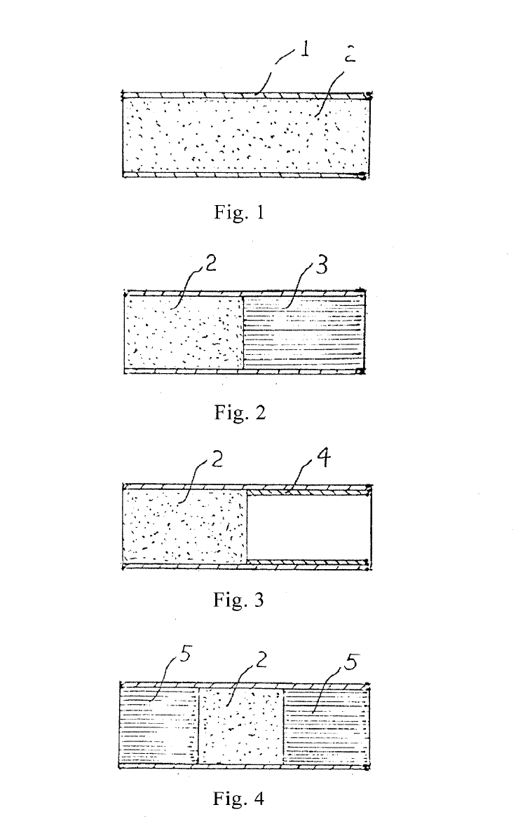

As shown in FIG. 1, this new TRSD tip has moudling paper 1 and tip filtering core 2, which is made of short fibrefibre. TRSD tip's moulding procedure doesn't need any adhesive bond, moulding material or other adhesion carrier. The short fibre can be natural plant fibre including conton, linen, bamboo, grass, timber, etc. The timber fibrewoodpulp can be woodpulp short pile fibre. As shown in FIG. 2, the tips are multiple tips, of which the core 2 is covered by core 3 made of CA or PF, which can both satisfy the requirement of consumers and improve the aspect of cigarette, as the cross section of timber fibrewoodpulp is not as smooth as CA. As shown in FIG. 3, the tip is partly hollow 4. As mentioned above, the cross section of timber fibrewoodpulp is not smooth; the hollow part of tips or CA and PF tips instead could improve the aspect and save the cost. As shown in FIG. 4, this tip is the triple-tip. The forepart is CA or PF core5, middle part is timber core 2, and the end is CA or PF core 5 again.

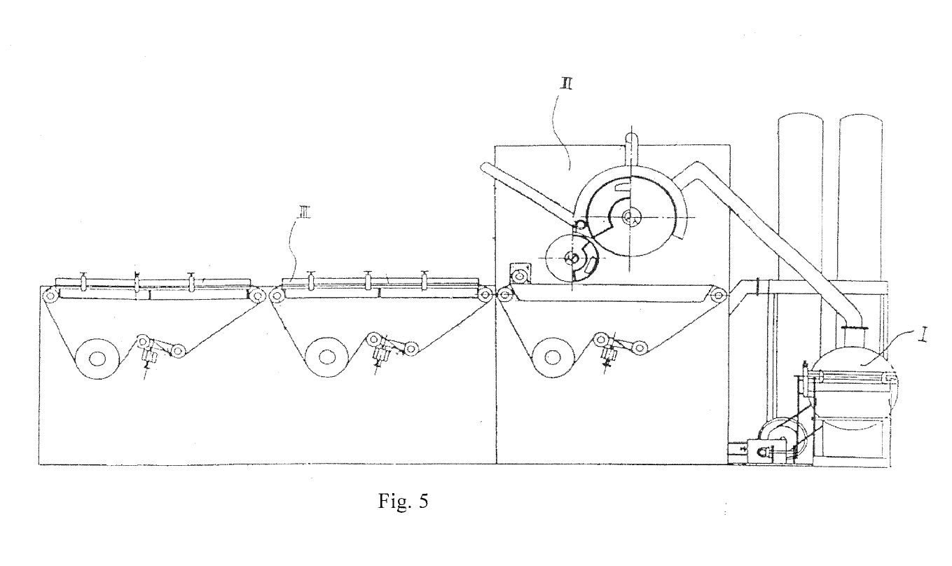

As shown in FIG. 5, this set of timber fibrewoodpulp moulding machine has three parts: timber shivering equipment 1, vacuum absorption and entwisting equipment 2, passive transportation and tip moulding equipment 3.

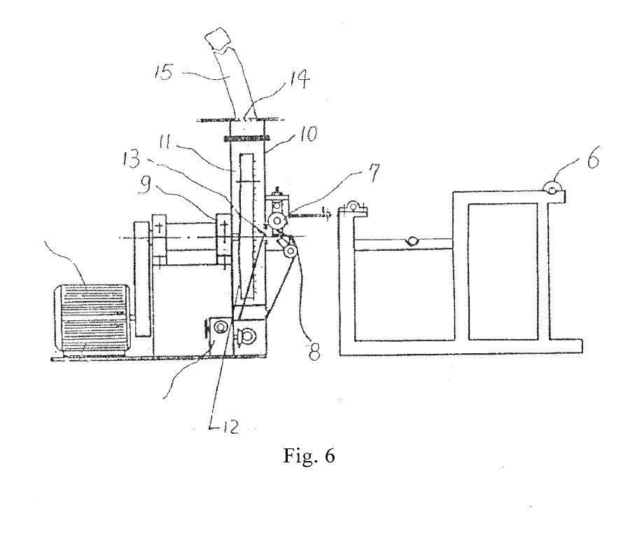

As shown in FIG. 6, the filtering material shivering machine has a main frame with a rotary shaft 6, which can be one horizontal shaft located on each a jar bearing of two ends of the main frame or two extension shafts located on each end of the main frame. This horizontal shaft is inserted in the paper moulding cabinet which is used for handling the timber fibrewoodpulp slurry with average fibre length 2.7 mm per length, 3.4 mm per weight, 685 g/m2, thickness (mm) 1.27, density (g/cm3) 0.54, broken stress (kPa) 685, water content (%) 8, extraction (%) 0.16, ISO whiteness (%) 87.0, fibration (%) 100, absorption time (second/g) 1.5, absorption capacity (g/g) 9.8. Crash gear 7 is located at the front of the frame with press lines on it. Opposite the crash gear, a corresponding press platform or rotating axis works with crash gear to drive the transportation belt. At the rear of the crash gear, there is a shivering machine 9 including shell 10, shivering cabinet 11, and shivering round shaft 12. There are also input 13 and output 14 which is connected to material transportation pipeline 15 which is driven by vacuum pressure to send the separated timber short fibre into the tip vacuum absorbing and entwisting equipment.

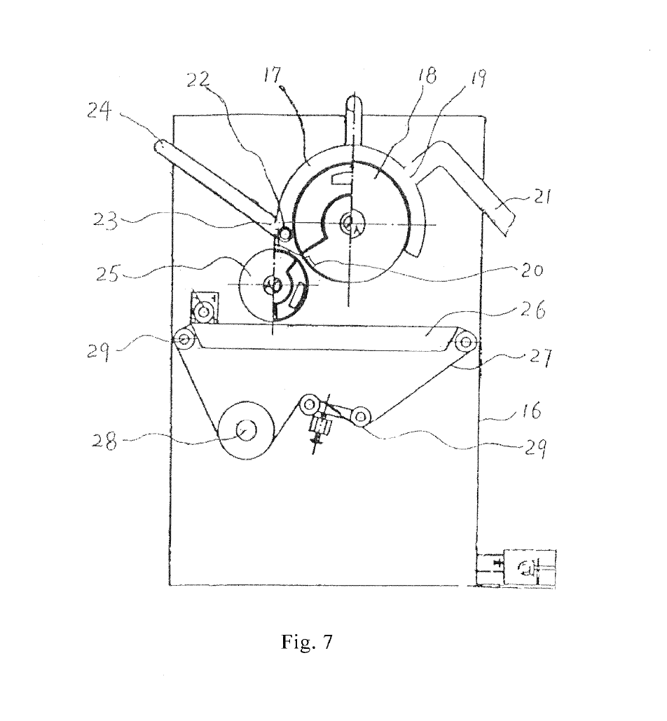

As shown in FIG. 7, the vacuum absorbing and entwisting equipment has the frame 16, on which there is an enclosed molding cabinet 17. In side the cabinet there is a molding rotating plate 18. The molding cabinet has input 19 and outlet 20. The input 19 is connected with material transportation pipeline 21, which is connected with the outlet of the timber shivering machine. The molding rotating plate 18 is vertically positioned with the central axis. This hollow rotating plate consists of fixed inner side and rotational exterior side. It has two partitions divided by clapboard. One is vacuum cabinet connected with vacuum air pump on the input side, the other one is ground pressure cabinet on the outlet side. The clapboard is riveted on the inner side of the molding rotating plate. The molding rotational plate 18 is encircled by a molding slot which would form an absorbing slot of semi-circle cross section with the filtering net inside the hollow molding rotational plate 18. There is also the molding brush 22 in molding cabinet, which is riveted onto the frame. The brush is sunken to semi-circle track which is just opposite to the track on the molding rotational plate 22. After entering the molding cabinet, timber short fibre can be evenly absorbed to the semi-circle track, and driven and brushed into semi-circle configuration by the molding brush through the rotation of the molding plate 18. Therefore, there exists a material returning intake 23 located on the shell just next to the molding brush 22. Material returning intake is connected with material returning pipe line 24. There is also a counter-rotational plate 25, which rotates on the other way compared with the molding rotational plate 18. This counter-rotational plate has the same structure as the molding rotational plate 18 with a material-taking platform 26 under the ground-pressure cabinet. The platform is a hollow one with vacuum absorbing hole and covered with transmission belt 27, which drives with platform 26, driver 28 and transmission wheel 29. The vacuum room inside the molding rotational plate 18, counter-rotational plate 25 and material intaking platform 26 is joined with the vacuum air pump through the ducts.

In order to keep the configuration of the fibre from the molding rotational plate, the counter-rotational plate is designed as the similar slot with the semi-circle cross section. A concave track can be made on the material intake platform 26 at the end of the transmission belt to force the cross section of this part of transmission belt into semi-circle.

Through this equipment, the timber short fibre is to be absorbed, groomed, and transported by the transmission belt into the next stage: passive transportation and entwist.

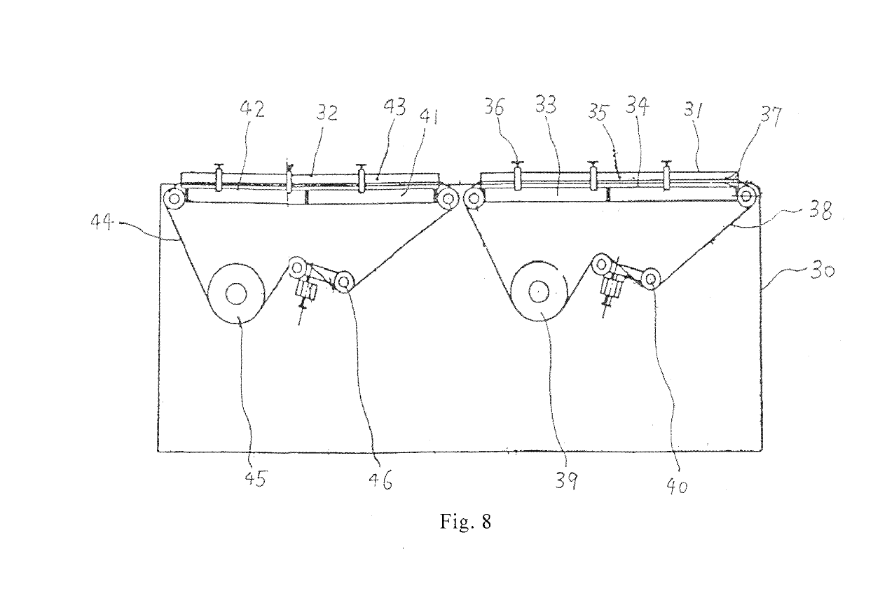

As shown in FIG. 8, the passive transmission and entwisting equipment has the main frame 30 with front molding gun 31 and rear molding gun 32. The front molding gun 31 is riveted to the molding platform 33. Front molding gun 31 consists of motherboard 34 and cover board 35. Motherboard is pined to the molding platform 33, and the cover board is stationed onto the motherboard 34 by the adjustable press claw 36. The two molding guns have a semi-circle slot each. These two slots compose the gun chamber of which the intake has a bulge configuration. The rolling transmission belt 38 is rolled up as soon as entering the molding gun wrapping up the timber fibre woodpulp, pressing it into strip as well as transporting it along. The transmission belt 38 is driven around the molding platform 33, molding gun chamber, driver 39 and tension-wheel. The rear molding gun 32 has the same structure as the front one except the diameter of the rolling transmission belt is more close to the one of the standard tips.

The whole process of the fibre passive transmission is described as below: the fibrefibre is transported into the intake 37 through the transmission belt 38 which is rolled up inside the gun chamber. During this process, the fibrefibre is also rolled up, further pressed, entwisted and made into the configuration which reaches the standard of the tip strip to get ready for the next process in which the tip molding machine will turn the strip into stand cigarette tips.

The embodiments of the invention in which an exclusive property or privilege is claimed are defined as follows:

1. A filter tip with high efficiency in reducing the amount of tar residue after burning, comprising forming paper and tip core, is characterized by tip core being made of short fibres.

2. The filter tip according to claim 1, wherein the short fibres are natural plant fibres.

3. The filter tip according to claim 2, wherein the natural plant fibre are woodpulps.

4. The filter tip according to claim 3, wherein the woodpulps are woodpulp short pile fibres.

5. The filter tip according to claim 1, 2, 3, or 4, wherein the filter tip is multiple tip, i.e. outside of woodpulp materials cellulose acetate (CA) or polypropylene fibre (PF) is configured to form the multiple tip.

6. The filter tip according to claim 1, 2, 3, or 4, wherein hard forming paper enwraps the outer layer of tip core of woodpulp materials, outside of which be vacancy; or outside of woodpulp tip core in the general forming paper, hollow tube is configured to form hollow multiple tips.

7. The filter tip according to claim 1, 2, 3, or 4, wherein CA or PF is used as front tips materials, woodpulp as intermediate materials and CA or PF as outer tips materials to form ternary tips.

8. An apparatus for producing the filter tip with high efficiency in reducing the amount of tar residue after burning, comprises an equipment for woodpulp materials shivering, an equipment for vacuum absorption and entwisting, an equipment for tip-figuration passive transportation, wherein the woodpulp material shivering equipment consists of rotating shaft, which could be located on the frame of the machine, crash gear on the front of the frame, and shivering machines behind the frame including machine shell, shivering cabinet, and shivering round shaft, the machine shell having the input and output; wherein the vacuum absorbing and entwisting equipment is an enclosed molding cabinet with input and output on the shell, this molding cabinet has two partitions, which are vacuum room connected with vacuuming machine with ducts on the input side, and ground-air pressure room on the output side, partition board is relatively immobile to the machine frame, gas-permeable mesh is designed just between the inner room of hollow molding rotating plate and molding slots which are at the brim of the molding rotating plates, there is a material-returning outlet on the shell, which is connected to the material-returning pipe, there is a hollow product-accepting platform with a vacuum absorbing hole at the rear of ground-air pressure room and output, the platform works with a transportation belt, driver and transmission, wherein the tip-configuration passive transportation device actually consists of front molding gun and rear molding gun which are riveted on the frame, the front molding gun has the motherboard and cover board each with a semi-circle slot, the two slots compose the gun chamber of which the intake has a bugle configuration, there is also a tip-rolling transportation belt works with driver and tension-wheel.

9. The apparatus according to claim 8, wherein the rotating would be one shaft located on the woodpulp material shivering equipment, pressing grains are configured on the crash gear, the shivering round shaft can be vertical round plate with shivering needles or horizontal cylinder with shivering needles, wherein in the vacuum absorbing and entwisting equipment there is a counter-rotational plate between transmission belt and output, the hollow counter-rotational plate has two partitions divided by a clapboard, one is vacuum cabinet connected opposite to the ground pressure cabinet of the molding rotating plate, the other is ground pressure cabinet opposite to the absorption hole of the material-taking platform, the counter-rotational plate rotates right about opposite to the molding rotating plate, wherein in the tip-figuration passive transportation device the diameter of transmission belt enwrapped by the gun chamber of the molding gun, is almost equal to that of the standard filtering tip.

10. The apparatus according to claim 9, wherein in the woodpulp material shivering equipment rotating shaft is two extension shafts located on each end of the machine, the shivering round shaft can be horizontal cylinder with shivering needles, the crash gear is connected to an electromotor by a gear-box; wherein in the vacuum absorbing and entwisting equipment the section of gas-permeable mesh and molding slots are semi-round tracks of slots, there is a molding brush in the molding cabinet, which is riveted to the frame through the rotating shaft, the brush is sunken into another semi-circle track which is just opposite to the semi-circle tracks of slots on the molding rotating plate, the molding rotating plate, the counter-rotational plate and product-accepting platform are connected to the vacuum air pump by the ducts, respectively, wherein in the tip-figuration passive transportation advice, the cover board is fixed to the motherboard by an adjustable plier.
